(19) United States
(12) Patent Application Publication
(10) Pub. No.: US 2010/0049752 A1
(43) Pub. Date: Feb. 25, 2010

(54) Dynamic word translation system and method thereof

(75) Inventors: Chaucer Chiu, Taipei (TW); Tao Zhou, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/230,049

(22) Filed: Aug. 22, 2008

(51) Int. Cl. G06F 17/30; G06F 17/28

(52) U.S. Cl. 707/204; 704/7; 707/E17.007

(57) ABSTRACT

A dynamic word translation system and the method thereof are provided. By simulating key-in for duplication operations, a word is extracted to a buffer area for translation and management. This solves the problem that word translations are often interfered with window switching in the prior art. Therefore, the translation operations of the invention are more convenient.

### BACKGROUND OF THE INVENTION

1. Field of Invention

The present invention relates to a translation system and the method thereof and more particularly to a dynamic word translation system that simulates key entering to perform duplication operations and the method thereof.

2. Related Art

In recent years, with the popularity and development in computer and Internet, multilingual documents are widely circulated. Software for translating various languages is thus invented. Generally speaking, translation software has a word input field for the user to enter a word for searching and translating. There are usually two methods of entering the word: one is to key in the word in the word input field; the other is to copy and paste a selected word into the word input field. The translation software then outputs a translation result.

However, either of the above-mentioned word input methods have its inconvenience in practice. Therefore, some vendors provide word input operations based on the position of the cursor. However, this method can only extract an entire word instead of some appropriate area of interest to the user. For example, when the user moves the cursor over the word ‘overbid’, he or she cannot select to translate ‘over’ or ‘bid’ only. Therefore, the prior art has some limitation. Besides, the conventional method may easily capture a word of no interest to the user or supply no word when he or she switches windows. In other words, word translations are often interfered by window switching.

In summary, there has always been interference to word translations in the prior art when switching windows. It is thus imperative to provide a solution.

### SUMMARY OF THE INVENTION

In light of the above drawbacks in the conventional technology, the invention discloses a dynamic word translation system and the method thereof.

The disclosed dynamic word translation system includes: a buffer module, a tag module, a capture module, and a translation module. The buffer module temporarily stores data. The tag module produces a tag word through the selection to the continuous string. The capture module triggers a capture according to a trigger condition and stores the tag word in the buffer module. The translation module loads the tag word from the buffer module for translation, and generates a display block to show the translation result.

The disclosed dynamic word translation method includes the steps of: generating a tag word through the selection of a continuous string; triggering a capture according to a trigger condition and storing the tag word in the buffer module; and loading the tag word from the buffer module for translation and generating a display block for showing the translation result.

The disclosed system and method as described above differ from the prior art in which the invention performs the duplication operation by simulating key-in and captures word to the buffer module for translation and management. The disclosed techniques can facilitate translation operations.

### BRIEF DESCRIPTION OF THE DRAWINGS

The invention will become more fully understood from the detailed description given herein below illustration only, and thus is not limitative of the present invention, and wherein:

FIG. 1 shows a block diagram of the disclosed dynamic word translation system;

FIG. 2 shows a flowchart of the disclosed dynamic word translation method;

FIGS. 3 to 6 are schematic views translating the tag word according to the invention; and

FIG. 7 is a schematic view of the setting window according to the invention.

### DETAILED DESCRIPTION OF THE INVENTION

The present invention will be apparent from the following detailed description, which proceeds with reference to the accompanying drawings, wherein the same references relate to the same elements.

Those Chinese characters shown in the drawings are just mentioned for describing the embodiments and are substantially irrelevant to any technical matters.

Before explaining the disclosed dynamic word translation system and method, technical terms used herein are first defined as follows. The buffer module referred herein can temporarily hold data, such as the clipboard in the Windows operating system (OS). The trigger condition is the correspondence relation between a key-in message (i.e., a hotkey) and a capture operation message (e.g., duplication). For example, if the trigger condition has the key ‘ALT’ on the keyboard as the key-in message, the corresponding capture operation message is ‘duplicate’. When the keyboard status function (e.g., XkbGetState) detects that the user enters the ‘ALT’ key, the system immediately execute duplication (e.g., using the built-in system function XTestFakeKeyEvent to simulate the simultaneous key-in of ‘Ctrl’ and ‘C’).

Besides, the waiting time is the delay time of the system for the user to adjust according to hardware devices, OS, or applications to prevent application programs from word capture failure due to slow response. The tag area is produced by continuous selection and motion of the cursor. In addition, it can also be the ranged between the cursor positions corresponding to two successive clicks of the mouse. The waiting time and the trigger condition can be defined by the user through a setting window, to be detailed hereinafter.

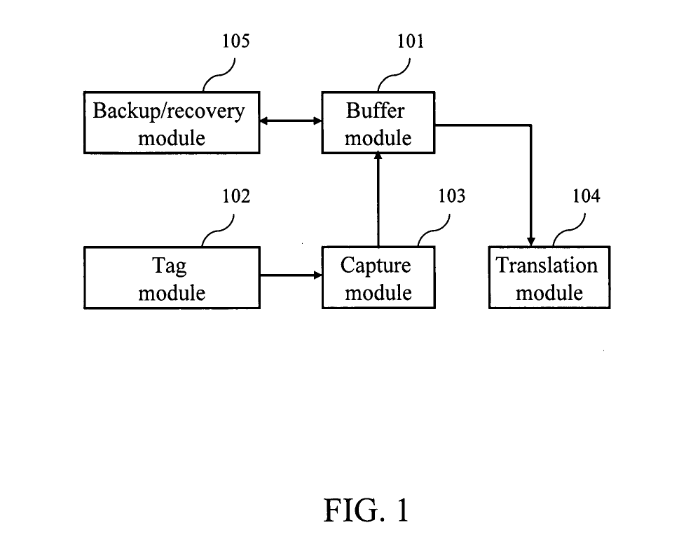

We first describe the disclosed dynamic word translation system, whose block diagram is shown in FIG. 1. The disclosed system includes: a buffer module 101, a tag module 102, a capture module 103, a translation module 104, and a backup/recovery module 105. The buffer module 101 temporarily stores data that can be readily overwritten or deleted (e.g., stored in memory). The tag module 102 generates a tag word through the selection of a continuous string. The selection of a continuous string can be done by continuous selection and motion of the cursor or defined by the range between the cursor positions corresponding to two successive clicks of the mouse. A tag word is generated according to the word in the tag area. The tag area can be displayed by contrast, complement, and flashing.

The capture module 103 triggers a capture operation according to a trigger condition. After the waiting time, it captures and stores the tag word in the buffer module 101. The trigger condition and waiting time referred herein have been defined before and are not repeated here. The translation module 104 loads the tag word from the buffer module 101 for translation, and generates a display block for showing a translation result. The display block is a floating window displayed according to the cursor position. For example, the display block can be a floating window whose center or one corner is at the cursor position.

Moreover, the disclosed system can further include a backup/recovery module 105 or backing up data temporarily stored in the buffer module 101 as a backup message before the capture module 103 captures the tag word. For example, when the buffer module 101 stores other temporary data in memory, the backup/recovery module 105 can write those data (i.e., the backup message) tin a file before the capture module 103 captures the tag word so that it is less likely to be carelessly overwritten or deleted. After the display block is closed, the backup message is recovered into the buffer module 101. The closure of the display block can be determined from the cursor position. For example, when the cursor moves out of the display region of the floating window, it is closed automatically. Besides, the system can further include a setting window for setting the trigger condition and waiting time.

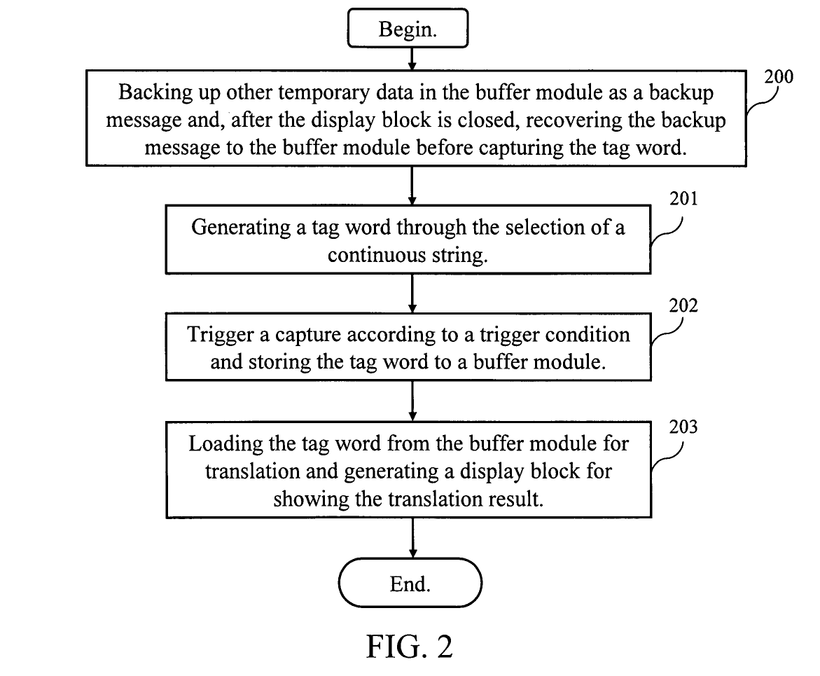

FIG. 2 is a flowchart of the disclosed dynamic word translation method. The disclosed method includes the following steps. Step 201 generates a tag word through the selection of a continuous string. Step 202 triggers a capture according to a trigger condition and stores the tag word in the buffer module 101. Step 203 loads the tag word from the buffer module 101 to the translation module 104 for translation, and generates a display block for showing the translation result. Besides, the method can have another step before step 201 to back up other temporary data in the buffer module 101 as a backup message and recover the backup message to the buffer module 101 after the display block is closed (step 200). Moreover, the method further includes the step of using a setting window to set the trigger condition and the waiting time.

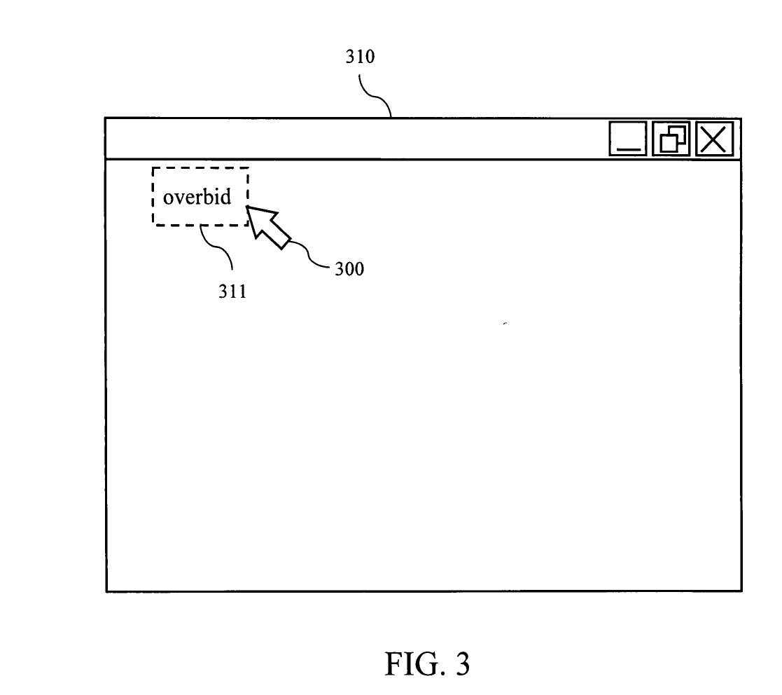

In the following, an embodiment is described with reference to FIGS. 3 to 7. In particular, FIGS. 3 to 6 are schematic views of translating a tag word according to the invention. Please first refer to FIG. 3. The translation program according to the invention can first back up other temporary data in the buffer module 101 (e.g., text ‘abc’) as a backup message using the backup/recovery module 105. When the user encounters an unknown word in the display window 310 (e.g., the word ‘overbid’), he or she moves the cursor 300 to the word and make a selection of a continuous string. The tag module 102 then generates a tag word 311. In this example, the selection is done by clicking the left side of the letter ‘o’, holding the button, and moving to the right side of the letter ‘d’, producing a tag area. The tag word 311 (i.e., ‘overbid’) is generated according to the word in the tag area (i.e., ‘overbid’).

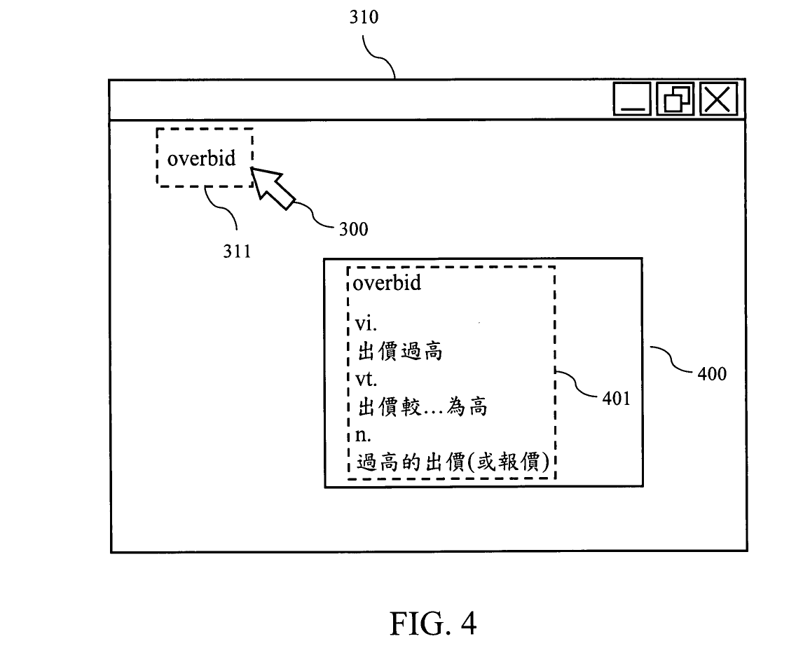

Afterwards, the capture module 103 triggers a capture and stores the tag word 311 (e.g., ‘overbid’) in the buffer module 101 according to the trigger condition (e.g., when the user hits the hotkey ‘ALT’). Afterwards, the translation module 104 loads the tag word 311 from the buffer module 101 for translation. It further generates a floating window 400 (i.e., display block) schematically shown in FIG. 4 for showing the translation result 401 of the tag word 311.

The floating window 400 may be displayed according to the cursor position 300. For example, the center (not shown) of the floating window 400 can be located at the cursor position 300. Alternatively, the cursor position 300 corresponds to one corner of the floating window 400. Whether the cursor position 300 is used as the center or one corner of the floating window 400, it is closed once the cursor 300 moves out of it or at a distance away from it. The backup message (i.e., ‘abc’) is recovered to the buffer module 101.

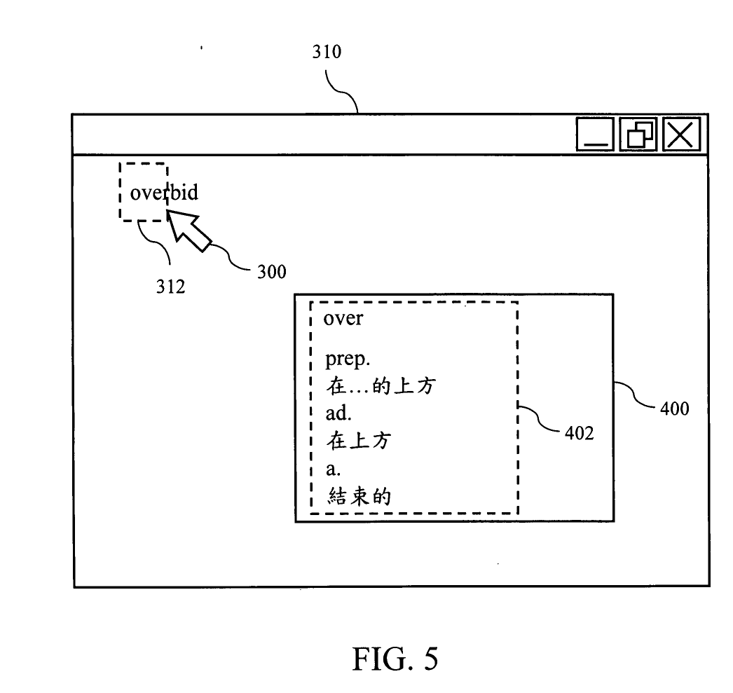

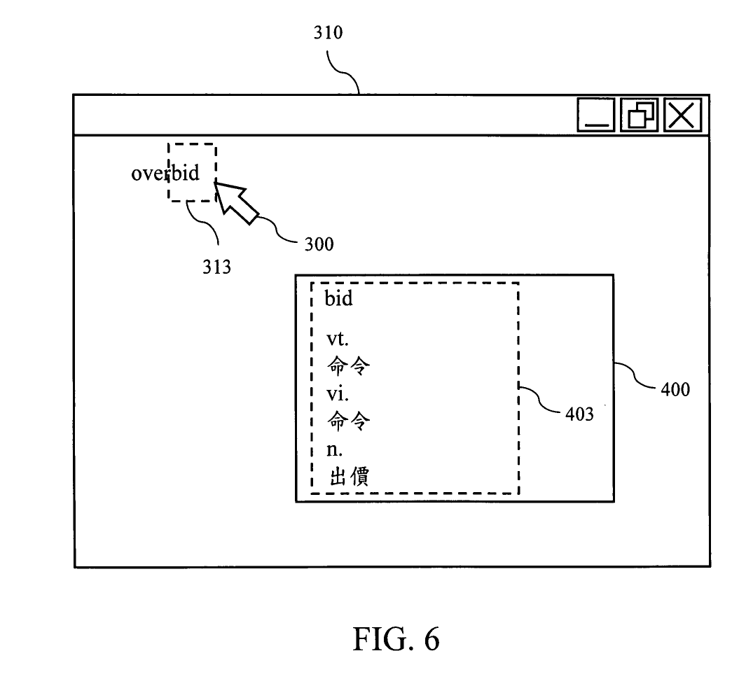

In the following, FIGS. 5 and 6 are used to describe how a word is selected. Please refer to FIG. 5 first. Many words (e.g., ‘overbid’) in English consist of different words (e.g., ‘over’ and ‘bid’). If the user is not clear with only some part of a word (e.g., ‘over’), he or she can generate the tag word 312 (e.g., ‘over’) by appropriately selecting the tag area. In this example, one simply clicks the left side of the letter ‘o’, holds the button, and moves to the right of the letter ‘r’. As described before, a floating window 400 is produced to display the translation result 402 of the tag word 312.

On the other hand, if the user is only interested in the other part of the word (e.g., ‘bid’), he or she can follow the above-described method to appropriately select and generate the tag word 313 using the mouse 300. Likewise, a floating window 400 is generated to display the translation result 403 for the tag word 313. It should be emphasized that the self-selected tag area can also be marked by the range defined by the cursor positions 300 between two successive clicks of the mouse in addition to the above-mentioned method. The tag area can be displayed by contrast, complement or flashing, so that the user knows clearly the marked area.

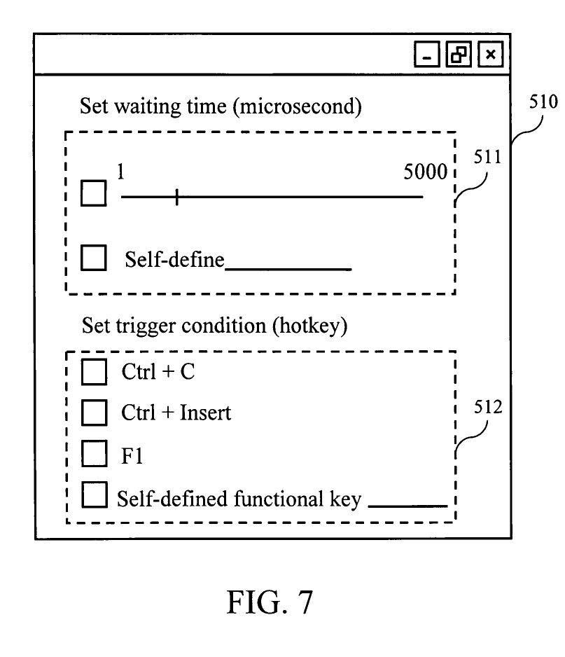

Finally, FIG. 7 explains how to set the waiting time and the trigger condition using a setting window. It shows the setting window according to the invention. If the user wants to select appropriate waiting time and trigger condition according to the hardware configuration, OS, or application programs, he or she can perform the settings through the waiting time setting block 511 and the trigger condition setting block 512 in the setting window 510.

In other words, the user can click the waiting time setting block 511 in the setting window 510 to adjust the waiting time or enter the waiting time by hand. The user can click the trigger condition setting block 512 in the setting window 510 to select the hotkey (i.e., the trigger condition) for triggering the capture operation or define his or her own functional key (e.g., setting one or a combination of keys on the keyboard and/or mouse buttons), so that the tag word can be captured and stored in the buffer module 101.

In summary, the invention differs from the prior art in that it simulates key-in for the duplication operation. It captures words to a buffer are for translation and management. Using this technique, erroneous word translations can be avoided during window switching. Therefore, the problem of interference due to window switching in the prior art is solved. The invention thus facilitates the translation operations.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dynamic word translation system, comprising:
a buffer module for temporarily storing data;
a tag module for generating a tag word through the selection of a continuous string;
a capture module for triggering a capture and storing the tag word into the buffer module according to the trigger condition; and
a translation module for loading the tag word from the buffer module for translation and generating a display block for showing a translation result.

2. The dynamic word translation system of claim 1 further comprising a backup/recovery module for backing up other temporary data in the buffer module as a backup message and, after the display block is closed, recovering the backup message to the buffer module before the capture module captures the tag word.

3. The dynamic word translation system of claim 1, wherein the selection of a continuous string is defined by continuous cursor selection and motion, thereby generating a tag area.

4. The dynamic word translation system of claim 1, wherein the selection of a continuous string is defined by the cursor positions between two successive clicks of the mouse, thereby generating a tag area.

5. The dynamic word translation system of claim 3, wherein the tag area is displayed by contrast, complement, and flashing.

6. The dynamic word translation system of claim 4, wherein the tag area is displayed by contrast, complement, and flashing.

7. The dynamic word translation system of claim 1, wherein the trigger condition gives a correspondence relation between a key-in message and a capture operation message.

8. The dynamic word translation system of claim 1, wherein the display block is a floating window displayed according to the cursor position.

9. The dynamic word translation system of claim 7 further comprising a setting window for setting the trigger condition and the waiting time.

10. A dynamic word translation method, comprising the steps of:
generating a tag word through the selection of a continuous string;
triggering a capture according to a trigger condition and storing the tag word to a buffer module; and
loading the tag word from the buffer module for translation and generating a display block for showing a translation result.

11. The dynamic word translation method of claim 10 further comprising the step of backing up other temporary data in the buffer module as a backup message and, after the display block is closed, recovering the backup message to the buffer module before capturing the tag word.

12. The dynamic word translation method of claim 10, wherein the selection of a continuous string is defined by continuous cursor selection and motion, thereby generating a tag area.

13. The dynamic word translation method of claim 10, wherein the selection of a continuous string is defined by the cursor positions between two successive clicks of the mouse, thereby generating a tag area.

14. The dynamic word translation method of claim 12, wherein the tag area is displayed by contrast, complement, and flashing.

15. The dynamic word translation method of claim 13, wherein the tag area is displayed by contrast, complement, and flashing.

16. The dynamic word translation method of claim 10, wherein the trigger condition gives a correspondence relation between a key-in message and a capture operation message.

17. The dynamic word translation method of claim 10, wherein the display block is a floating window displayed according to the cursor position.

18. The dynamic word translation method of claim 16 further comprising the step of setting the trigger condition and the waiting time through a setting window.
